(19) United States
(12) Patent Application Publication
(10) Pub. No.: US 2008/0023527 A1
(43) Pub. Date: Jan. 31, 2008

(54) Method of permanently joining components formed from metallic materials

(76) Inventors: Gerhard Brenninger, Dorfen (DE); Hans Hornig, Gars am Inn (DE); Hans Katzmaier, Beimerstetten (DE)

Correspondence Address: MACMILLAN, SOBANSKI & TODD, LLC, ONE MARITIME PLAZA - FIFTH FLOOR, 720 WATER STREET, TOLEDO, OH, 43604, US

(21) Appl. No.: 11/484,342

(22) Filed: Jul. 11, 2006

(51) Int. Cl. A47J 36/02

(52) U.S. Cl. 228/101

(57) ABSTRACT

A method is provided for permanently joining a first metallic component that is formed from a 5000 series aluminum alloy material and a second metallic component that is formed from a steel alloy material. One of the first and second components is provided with a layer of an aluminum alloy material that is different from the 5000 series aluminum alloy material used to form the first and second metallic components, such as a layer of a 6000 series aluminum alloy material. The layer of the 6000 series aluminum alloy material can be provided as a coating on the selected one of the first and second components or in solid form. After the layer of the 6000 series aluminum alloy material can be provided on the selected one of the first and second components, the first and second components are secured together without the application of heat, such as by magnetic pulse welding, friction welding, and the like.

### BACKGROUND OF THE INVENTION

This invention relates in general to methods for permanently joining components that are formed from metallic materials. In particular, this invention relates to a method of permanently joining a first metallic component that is formed from a 5000 series aluminum alloy material and a second metallic component that is formed from a steel alloy material.

A wide variety of structures are manufactured by permanently joining first and second metallic components together. For example, in most land vehicles in use today, a drive train system is provided for transmitting rotational power from an output shaft of an engine/transmission assembly to an input shaft of an axle assembly so as to rotatably drive one or more wheels of the vehicle. A typical vehicular drive train system includes a hollow cylindrical driveshaft tube having first and second end fittings (such as tube yokes) that are permanently joined to the opposed ends thereof. Also, many land vehicles in common use, such as automobiles, vans, and trucks, include a frame assembly that is supported upon a plurality of ground-engaging wheels by a resilient suspension system. A typical vehicular frame assembly includes a plurality of structural components, including body structures, sub-frames, engine cradles, axle cradles, and suspension products, that are permanently joined together. There are also other areas in a typical vehicle, such as ground studs, fixing studs, etc. where first and second metallic components are permanently joined together.

In the past, all of the components in these and other structures have typically been formed from a single metallic material, such as steel. Steel has traditionally been the preferred material for manufacturing such components because of its relatively high strength, relatively low cost, and ease of manufacture. Components manufactured from steel and other metallic materials have been traditionally secured together by conventional welding techniques, which are well suited for use when the components being joined are formed from a single metallic material. As is well known, conventional welding techniques involve the application of heat to localized areas of two metallic members, which results in a coalescence of the two metallic members. Such conventional welding techniques may or may not be performed with the application of pressure and may or may not include the use of a filler metal. Although conventional welding techniques have functioned satisfactorily in the past, there are some drawbacks to the use thereof.

More recently, it has been found desirable to use a combination of two or more different metallic materials in the manufacture of these various structures. The use of such different metallic materials allows a desired overall strength characteristic for the structure to be achieved, while minimizing the overall weight thereof. Thus, for example, it is known to create a structure having some components that are formed from an aluminum alloy material and other components that are formed from a steel alloy material. In particular, the use of a 5000 series aluminum alloy, which has a relatively high magnesium content in comparison to other series of aluminum alloys, has been found to be desirable over more traditional aluminum alloys (such as 6000 series aluminum alloy, for example) because of its enhanced strength. However, it has been found to be relatively difficult to securely join a first component that is formed from a 5000 series aluminum alloy material and a second component that is formed from a steel alloy material. Thus, it would be desirable to provide a method of permanently joining a first metallic component that is formed from a 5000 series aluminum alloy material and a second metallic component that is formed from a steel alloy material.

### SUMMARY OF THE INVENTION

This invention relates to a method of permanently joining a first metallic component that is formed from a 5000 series aluminum alloy material and a second metallic component that is formed from a steel alloy material. Initially, one of the first and second components is provided with a layer of an aluminum alloy material that is different from the 5000 series aluminum alloy material used to form the first and second components. For example, the selected one of the first and second components may be provided with a layer of a 6000 series aluminum alloy material. The layer of the 6000 series aluminum alloy material can be provided as a coating on the selected one of the first and second components using any desired process, such as by hot-dipping, galvanizing, spraying, and the like. Alternatively, the layer of the 6000 series aluminum alloy material can be provided on the selected one of the first and second components in solid form, such as by a mechanical engagement using a foil or a tube. After the layer of the 6000 series aluminum alloy material can be provided on the selected one of the first and second components, the first and second components are secured together without the application of heat. This securement of the first and second components can be accomplished using any desired technique, such as by magnetic pulse welding, friction welding, and the like.

Various objects and advantages of this invention will become apparent to those skilled in the art from the following detailed description of the preferred embodiment, when read in light of the accompanying drawings.

### BRIEF DESCRIPTION OF THE DRAWINGS

FIG. 1 is a sectional elevational view showing a first step in the method of this invention, wherein first and second components are provided that are formed from different metallic materials.

FIG. 2 is a sectional elevational view showing a second step in the method of this invention, wherein one of the first and second components illustrated in FIG. 1 is provided with a layer of material that is different from the materials used to form the first and second components.

FIG. 3 is a sectional elevational view showing a third step in the method of this invention, wherein the first and second components illustrated in FIG. 2 are permanently joined together.

FIG. 4 is an exploded perspective view of a portion of a driveshaft assembly including a driveshaft tube and an end fitting shown prior to being assembled and permanently joined together in accordance with the method of this invention.

FIG. 5 is a schematic perspective view of a vehicle frame assembly including a pair of side rails having a plurality of cross members permanently joined thereto in accordance with the method of this invention.

### DETAILED DESCRIPTION OF THE PREFERRED EMBODIMENT

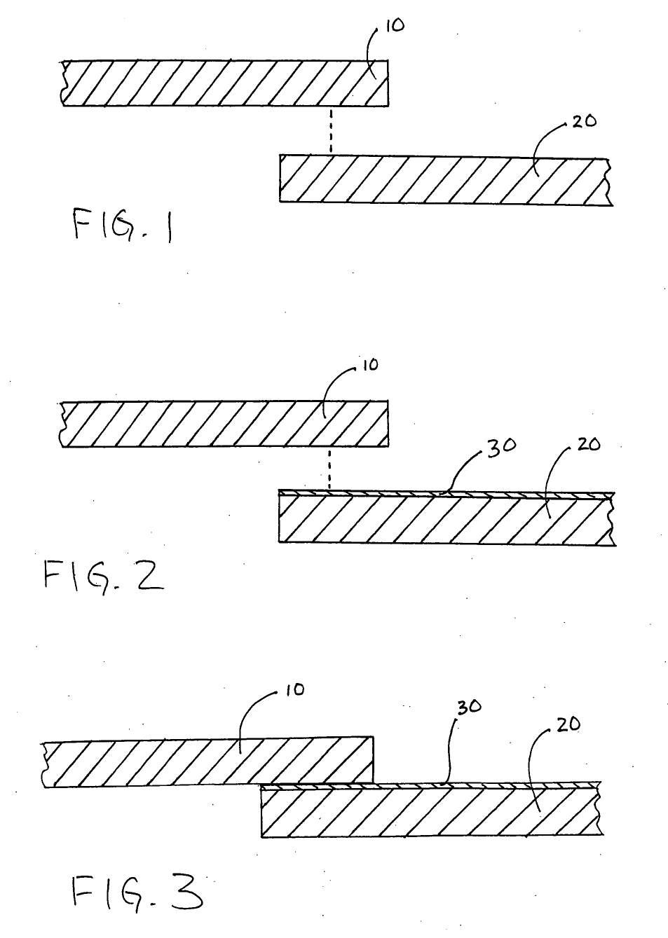

Referring now to the drawings, there is illustrated in FIG. 1 a first step in the method of this invention, wherein a first metallic component 10 and a second metallic component 20 are provided. As will be explained in greater detail below, the first and second metallic components 10 and 20 are intended to be representative of any metallic structures that are desired to be permanently secured together. The first and second metallic components 10 and 20 can have any desired shapes or combination of shapes including, for example, flat and tubular configurations.

The first and second metallic components 10 and 20 are formed from different metallic materials. In the illustrated embodiment, the first metallic component 10 is formed from a conventional steel alloy material, and the second metallic component 20 is formed from a 5000 series aluminum alloy material. As is known in the art, 5000 series aluminum alloy material is characterized by a relatively high magnesium content in comparison to other series of aluminum alloys and has been found to be desirable over more traditional aluminum alloys (such as 6000 series aluminum alloy, for example) in certain applications because of its enhanced strength. Alternatively, the first metallic component 10 may be formed from a 5000 series aluminum alloy material, and the second metallic component 20 may be formed from a conventional steel alloy material. However, the first metallic component 10 and the second metallic component 20 may be formed from any desired metallic materials that are different from one another.

In the second step of the method of this invention illustrated in FIG. 2, one of the first and second components 10 and 20 illustrated in FIG. 1 is provided with a layer of material 30 that is different from the materials used to form the first and second components 10 and 20. In the illustrated embodiment, the layer of material 30 is applied to a surface of the second metallic component 20. However, if desired, the layer of material 30 can be applied to a surface of the first metallic component 10. The layer of material 30 is preferably formed from a material that facilitates the permanent joining of the first and second components 10 and 20 in the manner described below. For example, the layer of material 30 may be formed from a 6000 series aluminum alloy material.

The layer of material 30 can be provided as a coating on the selected one of the first and second metallic components 10 and 20 using any desired process. For example, the layer of material 30 can be applied to the selected one of the first and second metallic components 10 and 20 by hot-dipping, galvanizing, spraying, microwave plasma-based coating, powder sintering, and any other coating process that creates a sufficient bond or adherence having a sufficiently small gap between the coating and the coated partner to avoid electrochemical corrosion. Alternatively, the layer of material 30 can be provided on the selected one of the first and second components in solid form. For example, the layer of material 30 can be applied to the selected one of the first and second metallic components 10 and 20 by a mechanical engagement using a foil or a tube.

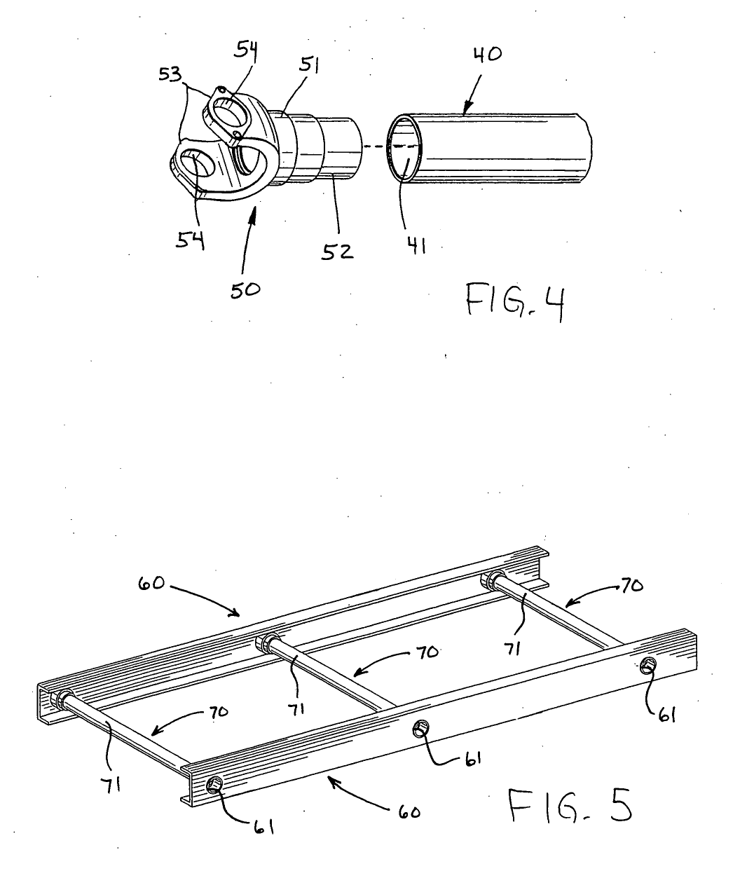

In a third step of the method of this invention illustrated in FIG. 3, the first and second metallic components 10 and 20 are permanently joined together. Preferably, the first and second metallic components 10 and 20 are permanently joined together by a process that does not involve the application of a significant amount of heat to the first and second metallic components 10 and 20, such as occurs in conventional welding processes. The application of heat can cause undesirable distortions and weaknesses to be introduced into the first and second metallic components 10 and 20.

For example, the first and second metallic components 10 and 20 can be permanently joined together by magnetic pulse welding. Magnetic pulse welding is a well known process that can be used to permanently join two or more metallic workpieces. Typically, a magnetic pulse welding process is performed by initially disposing portions of first and second workpieces in an overlapping relationship. Then, an electromagnetic field is generated adjacent to a selected one of the overlapping portions of the first and second workpieces. When this occurs, a large pressure is exerted on the selected one of the first and second workpieces, causing it to move toward the other of the first and second workpieces. In a magnetic pulse welding process, a relatively high intensity electromagnetic field is generated. As a result, the first workpiece impacts the second workpiece at a relatively large velocity, thereby causing the first workpiece to be permanently secured to the second workpiece without the generation of a significant amount of heat therein.

Alternatively, the first and second metallic components 10 and 20 can be permanently joined together by friction welding. Friction welding is a well known process that can be carried out by moving a first workpiece relative to a second workpiece along a common interface, while applying a compressive force thereacross. The friction heating generated at the interface softens both workpieces and, when they become plasticized, the interface material is extruded out of the edges of the joint so that clean material from each workpiece is left along the original interface. The relative motion between the first and second workpieces is then stopped, and a higher final compressive force may be applied before the joint is allowed to cool. In a typical friction welding process, no molten material is generated, and the weld is formed in the solid state. Friction welding can include rotary friction welding (wherein one workpiece is rotated against the other), linear friction welding (wherein one workpiece is moved linearly against the other), and friction stir welding (wherein a tool is rotated and slowly plunged into the interface between the first and second workpieces). In each instance, friction welding causes the first workpiece to be permanently secured to the second workpiece without the generation of a significant amount of heat therein.

As mentioned above, the first and second metallic components 10 and 20 are intended to be representative of any metallic structures that are desired to be permanently secured together. For example, as shown in FIG. 4, the first and second components 10 and 20 can be embodied as a hollow cylindrical driveshaft tube, indicated generally at 40, and an end fitting, indicated generally at 50, for use in a driveshaft assembly for transmitting rotational power from an output shaft of a source of rotational energy to an input shaft rotatably driven device. The illustrated driveshaft tube 40 is generally hollow and cylindrical in shape and includes an inner surface 41. The illustrated end fitting 50 is a tube yoke that includes a cylindrical body portion 51 having an outer surface 52. A pair of opposed yoke arms 53 extend axially from the body portion 51. A pair of aligned openings 54 are formed through the yoke arms 53 and are adapted to receive conventional bearing cups (not shown) of a universal joint cross therein. As discussed above, the driveshaft tube 40 can be formed from a steel alloy material and the end fitting 50 can be formed from a 5000 series aluminum alloy material. Alternatively, the driveshaft tube 40 can be formed from a 5000 series aluminum alloy material and the end fitting 50 can be formed from a steel alloy material. Additionally, the layer of material 30 can be applied to either the outer surface 52 of the end fitting 50 or to the inner surface 41 of the driveshaft tube 40. The outer surface 52 of the end fitting 50 can be inserted telescopically within the inner surface 41 of the driveshaft tube 40, and the two components can be permanently secured together in the manner described above.

As another example, as shown in FIG. 5, the first and second components 10 and 20 can be embodied as side rails, indicated generally at 60, and cross member, indicated generally at 70, for use in a frame assembly, such as for a vehicle. The illustrated side rails 60 extend longitudinally along the length of the frame assembly and have respective openings formed therethrough defining inner surfaces 61. The illustrated cross members 70 extend generally perpendicular to the side rails 60 and have respective outer surfaces 71. As discussed above, the side rails 60 can be formed from a steel alloy material and the cross members 70 can be formed from a 5000 series aluminum alloy material. Alternatively, the side rails 60 can be formed from a 5000 series aluminum alloy material and the cross members 70 can be formed from a steel alloy material. Additionally, the layer of material 30 can be applied to either the outer surfaces 71 of the cross members 70 or to the inner surfaces 61 of the side rails 60. The outer surfaces 71 of the cross members 70 can be inserted telescopically respectively within the inner surfaces 61 of the side rails 60, and the two components can be permanently secured together in the manner described above. Although only the side rails 60 and the cross members 70 are illustrated, it will be appreciated that frame components can include any other conventional body structures, sub-frames, engine cradles, axle cradles, and suspension products. There are also other vehicular applications, such as ground studs, fixing studs, and the like, which could be formed by the method of this invention.

In accordance with the provisions of the patent statutes, the principle and mode of operation of this invention have been explained and illustrated in its preferred embodiment. However, it must be understood that this invention may be practiced otherwise than as specifically explained and illustrated without departing from its spirit or scope.

What is claimed is:

1. A method of method of permanently joining first and second metallic components comprising the steps of:
(a) providing first and second metallic components;
(b) providing one of the first and second metallic components with a layer of material that facilitates the permanent joining of the first and second metallic components; and
(c) permanent joining the first and second metallic components.

2. The method defined in claim 1 wherein said step (a) is performed by forming the first metallic component from an aluminum alloy material and by forming the second metallic component from a steel alloy material.

3. The method defined in claim 2 wherein said step (b) is performed by forming the layer of material from an aluminum alloy material.

4. The method defined in claim 1 wherein said step (a) is performed by forming the first metallic component from a 5000 series aluminum alloy material and by forming the second metallic component from a steel alloy material.

5. The method defined in claim 4 wherein said step (b) is performed by forming the layer of material from a 6000 series aluminum alloy material.

6. The method defined in claim 1 wherein said step (b) is performed by one of hot-dipping, galvanizing, spraying, microwave plasma-based coating, and powder sintering.

7. The method defined in claim 1 wherein said step (b) is performed by mechanical engagement using one of a foil or a tube.

8. The method defined in claim 1 wherein said step (c) is performed by one of magnetic pulse welding and friction welding.

9. The method defined in claim 1 wherein said step (a) is performed by providing first and second driveshaft components.

10. The method defined in claim 9 wherein said step (a) is performed by providing a driveshaft tube as the first driveshaft component and an end fitting as the second driveshaft component.

11. The method defined in claim 1 wherein said step (a) is performed by providing first and second frame assembly components.

12. The method defined in claim 11 wherein said step (a) is performed by providing a side rail as the first frame assembly component and a side rail as the second frame assembly component.

13. The method defined in claim 11 wherein said step (a) is performed by providing the first and second frame assembly components from the group including side rails, cross members, body structures, sub-frames, engine cradles, axle cradles, and suspension products, ground studs, and fixing studs.
